(19) United States
(12) Patent Application Publication
(10) Pub. No.: US 2025/0208930 A1
(43) Pub. Date: Jun. 26, 2025

(54) APPLICATION PROGRAMMING INTERFACE (API) DOCUMENT GENERATION SYSTEM

(71) Applicant: Oracle International Corporation, Redwood Shores, CA (US)

(72) Inventors: Andrei Vorobiev, Seattle, WA (US); Igor Krisyuk, Renton, WA (US)

(73) Assignee: Oracle International Corporation, Redwood Shores, CA (US)

(21) Appl. No.: 18/393,273

(22) Filed: Dec. 21, 2023

(51) Int. Cl. G06F 9/54

(52) U.S. Cl. CPC G06F 9/541

(57) ABSTRACT

A target entity-specific API document generation system is disclosed that includes capabilities for generating an API document in accordance with the API functionality specified by a target entity. The system obtains an API document that is relevant to a source entity and converts the API document into a common interface format (CIF) application programming interface (API) document. The system then identifies one or more relevant portions within the CIF API document for further processing. The system identifies one or more component types within a relevant portion. The system identifies content related to a component type and then transforms the content related to the component type based on a set of transformation rules associated with the component type. The system then generates a target entity-specific API document for a target entity where the target entity-specific API document includes the transformed content related to the component type identified in the relevant portion.

### BACKGROUND

An Application Programming Interface (API) is a set of defined rules that enable different applications to communicate with one another. Concise and clear documentation is integral to API creation, especially since APIs change and evolve rapidly to handle new services and design features. For example, an entity (e.g., an enterprise or a cloud service provider (CSP)) may wish to develop a new service for its end users/customers. Instead of building libraries or tools for the new service from scratch, the entity can make use of existing APIs provided by cloud computing services from multiple providers (e.g., another CSP, an enterprise or a third party) to develop its new service. However, in order for the entity to be able to make use of these existing APIs from external cloud providers, the APIs have to be modified to a format that is compliant and consistent with the requirements of the entity.

Current approaches for using external APIs involve manually updating the APIs to describe the APIs in a format that is compliant and consistent with the requirements of the entity. However, these approaches do not have a clear standard or clear parameters for documenting APIs. Some approaches have been developed that can automatically provide interactive API documentation for APIs. For instance, APIs can be automatically documented using an API description format such as the OpenAPI Specification (also known as the Swagger Specification). Using such an API description format, an API can be documented in a clear and concise manner using a list of methods, parameters, and responses in a manner in which developers can better understand key interactions between web services and software components.

Techniques that provide automatic interactive API documentation still suffer from certain drawbacks. Although these techniques can be used to document APIs in a clear and concise manner, in order for an entity to utilize these APIs in its service, the APIs still have to be manually updated and documented to a format that is compatible with the API functionality and design requirements of the entity. Updating an API document manually can be a time consuming process and prone to errors. Thus, there is a need for developing techniques that facilitate more efficient API documentation that what is possible by existing implementations.

### BRIEF SUMMARY

The present disclosure relates generally to generating an Application Programing Interface (API) document for a target entity. More specifically, but not by way of limitation, this disclosure describes a technique for generating a target entity-specific API document based on an API document associated with a source entity. The target entity-specific API document that is generated is compliant and compatible with the API definitions and API functional requirements specified by the target entity.

In certain embodiments, an API document generation system is disclosed. The API document generation system obtains an API document that is relevant to a source entity and converts the API document into a common interface format (CIF) application programming interface (API) document. The system then identifies one or more relevant portions within the CIF API document for further processing. For a relevant portions in the relevant portions identified by the system for further processing, the system then identifies one or more component types within the relevant portion. For a component type in the component types, the system identifies content related to a component instance of the component type and transforms the content related to the component instance based on a set of transformation rules associated with the component type. The system then generates a target entity-specific API document for a target entity where the target entity-specific API document includes the transformed content related to the component instance identified in the relevant portion.

In certain examples, the CIF API document comprises a set of API definitions for describing one or more elements of the API document that is relevant to the source entity using a standard API description format.

In certain examples, the relevant portions within the CIF API document are identified by applying a filtering operation to the CIF API document. The relevant portions identify one or more resources in the CIF API document that are relevant to the target entity-specific API document. The relevant portions may also identify one or more generic portions of the CIF API document that are relevant to the target entity-specific API document.

In certain examples, the component types in the relevant portion represent operation types that are applied to a resource identified in the relevant portion. In certain examples, the content related to the component type identified in the relevant portion comprises information identifying the resource identified in the relevant portion. The information identifying the resource comprises path information used to access the resource, a description of an operation type applied to the resource, an operation identifier used to identify the operation type, the input parameters used by the operation type, the output parameters used by the operation type and the response schema associated with the operation type.

In certain examples, a transformation rule in the set of transformation rules transforms a portion of the content associated with the component type to generate a portion of the transformed content related to the component type identified in the relevant portion.

In certain examples, the portion of the content associated with the component type corresponds to an operation type and the transformation rule transforms the portion of the content associated with the operation type by classifying the operation type into a particular group from a set of groups and annotating the particular group with semantic information specific to the target entity. The transformation rule further transforms the portion of the content associated with the operation type by renaming the operation type into a format specified by the target entity.

In certain examples, the portion of the content associated with the component type corresponds to path information associated with an operation type and the transformation rule transforms the portion of the content associated with the path information by removing parameter information that identifies the source entity.

In certain examples, the portion of the content associated with the component type corresponds to an operation identifier associated with an operation type and the transformation rule transforms the portion of the content associated with the operation identifier by remaining the operation identifier into a format specified by the target entity.

In certain examples, the portion of the content associated with the component type corresponds to a data model associated with the component type and the transformation rule transforms the portion of the content associated with the data model by generating a new data model in a format specified by the target entity.

In certain examples, the target entity represents a target enterprise for which the target entity-specific API document is generated or a target cloud service provider for which the target entity-specific API document is generated.

Various embodiments are described herein, including methods, systems, non-transitory computer-readable storage media storing programs, code, or instructions executable by one or more processors, and the like. These illustrative embodiments are mentioned not to limit or define the disclosure, but to provide examples to aid understanding thereof. Additional embodiments are discussed in the Detailed Description, and further description is provided there.

### BRIEF DESCRIPTION OF THE DRAWINGS

Features, embodiments, and advantages of the present disclosure are better understood when the following Detailed Description is read with reference to the accompanying drawings.

FIG. 1 depicts a high level diagram of a computing environment including an API document generation system that includes capabilities for generating a target entity-specific Application Programing Interface (API) document as described herein, according to certain embodiments.

FIG. 2 depicts an example of a process for generating a target entity-specific API document, according to certain embodiments.

FIG. 3 describes additional details of the process for generating a target entity-specific API document, according to certain embodiments.

FIG. 4 illustrates an example of a target entity-specific API document for a target entity that is generated by processing one or more relevant portions from a CIF API document, according to certain embodiments.

FIG. 5 depicts an example of original content associated with a component instance in a relevant portion that is identified from a CIF API document for further processing, according to certain embodiments.

FIG. 6 depicts an example of transformed content associated with a component instance that generated for a relevant portion of a target entity-specific API document, according to certain embodiments.

FIG. 7 depicts an example of the details associated with a new model generated by the system as part of transformed content in a target entity-specific API document, in accordance with certain embodiments.

FIG. 8 is a block diagram illustrating one pattern for implementing a cloud infrastructure as a service system, according to at least one embodiment.

FIG. 9 is a block diagram illustrating another pattern for implementing a cloud infrastructure as a service system, according to at least one embodiment.

FIG. 10 is a block diagram illustrating another pattern for implementing a cloud infrastructure as a service system, according to at least one embodiment.

FIG. 11 is a block diagram illustrating another pattern for implementing a cloud infrastructure as a service system, according to at least one embodiment.

FIG. 12 is a block diagram illustrating an example computer system, according to at least one embodiment.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

The present disclosure relates generally to generating an Application Programing Interface (API) document for a target entity. More specifically, but not by way of limitation, this disclosure describes a technique for generating a target entity-specific API document based on an API document associated with a source entity. The target entity-specific API document that is generated is compliant and compatible with the API definitions and API functional requirements specified by the target entity.

As previously described, an entity (e.g., an enterprise or a cloud service provider (CSP)) may wish to develop a new service for its end users or customers using existing APIs provided by cloud computing services from multiple external entities (e.g., another public cloud provider, an enterprise or a third party). In order for the entity to utilize these external APIs in its service, the APIs have to typically be updated and documented to a format that is compatible with the API functionality and API design requirements of the entity. Current approaches for generating an API document that is compliant with the format and rules specified by the entity involve manually updating the API document to a format that is compatible with the API functionality and API design requirements of the entity.

The various embodiments described in the present disclosure address the deficiencies of existing approaches by disclosing a system that includes capabilities for generating a target entity-specific Application Programing Interface (API) document for a target entity from an API document associated with an external entity (also referred to herein as a source entity). The target entity-specific Application Programing Interface (API) document that is generated is compliant and compatible with the API definitions and API functional requirements specified by the target entity. The target entity-specific API document describes a set of API elements used by a target entity in accordance with the format and rules specified by the target entity. The API elements may include, for instance, path (endpoint) information associated with one or more resources used by the API, the operations applied to the resources, the input and output parameters for each operation, the authentication mechanisms needed by the API and other non-API related information (such as terms, contact information and license information) to use the API.

As described herein, a source entity may represent a company (e.g., an enterprise), a cloud service provider (CSP) or a third party entity that has an API document for describing various computing services used by the source entity. Different source entities may have different API for describing their APIs. Examples of API documents associated with a source entity may include, for instance, Software Development Kits (SDKs), Google® discovery documents, and so on. A target entity may represent a target enterprise for which a target entity-specific API document is to be generated. In certain cases, the target entity may also represent a target CSP (e.g., Oracle® Azure®, Amazon® and so on) for which a target entity-specific API document is to be generated.

In certain embodiments, an API document generation system is disclosed. The system obtains an API document that is associated with a source entity and first converts the API document into a common interface format (CIF) API document by creating API definitions for describing the elements of the API document associated with the source entity in a clear and concise manner. In a certain implementation, the API definitions are described using interactive API documentation that is provided using a standard API description format (e.g., the OpenAPI Specification). The system then transforms the CIF API document using a set of transformation rules to generate a target entity-specific API document that is compliant to a particular target entity.

In certain examples, the set of transformation rules represent multiple rules that may be applied sequentially, in parallel, or in an overlapping manner to the content described in the CIF API document. The content may include various types of operations (also referred to herein as operation types) that may be applied to resources described in the CIF API document. The content may also include additional information associated with the resource such as the path (endpoint) information used to access the resource, a description of the operation type, an operation identifier that is an optional unique string used to identify the operation type, the input parameters used by the operation type and the output parameters used by the operation type, the response schema associated with the operation type and so on.

Each transformation rule transforms a portion of the content described in the CIF API document in accordance with the format and rules specified by the target entity. The transformed content is then included by the system in a target entity-specific API document that is generated for the target entity. The transformed content describes the content of the CIF API document in accordance with the format and rules specified by the target entity. In certain examples, the transformed content may additionally include code/code artifacts that describes the content in accordance with the format and rules specified by the target entity. The disclosed system then includes the transformed content in target entity-specific API document and transmits the target entity-specific API document to a user of the system.

The target entity may utilize the target entity-specific API document to build services for its end users/customers in a cost-effective manner without having to create new libraries or tools for the new service from scratch. Additionally, since the target entity-specific API document is generated in a format that is compatible with the API design requirements of the target entity, it can directly be used in services developed by the target entity without requiring to be manually updated to the format and specifications required by the target entity. This results in the ability for the target entity to create and develop new services and/or modify existing services in a cost-effective and timely manner.

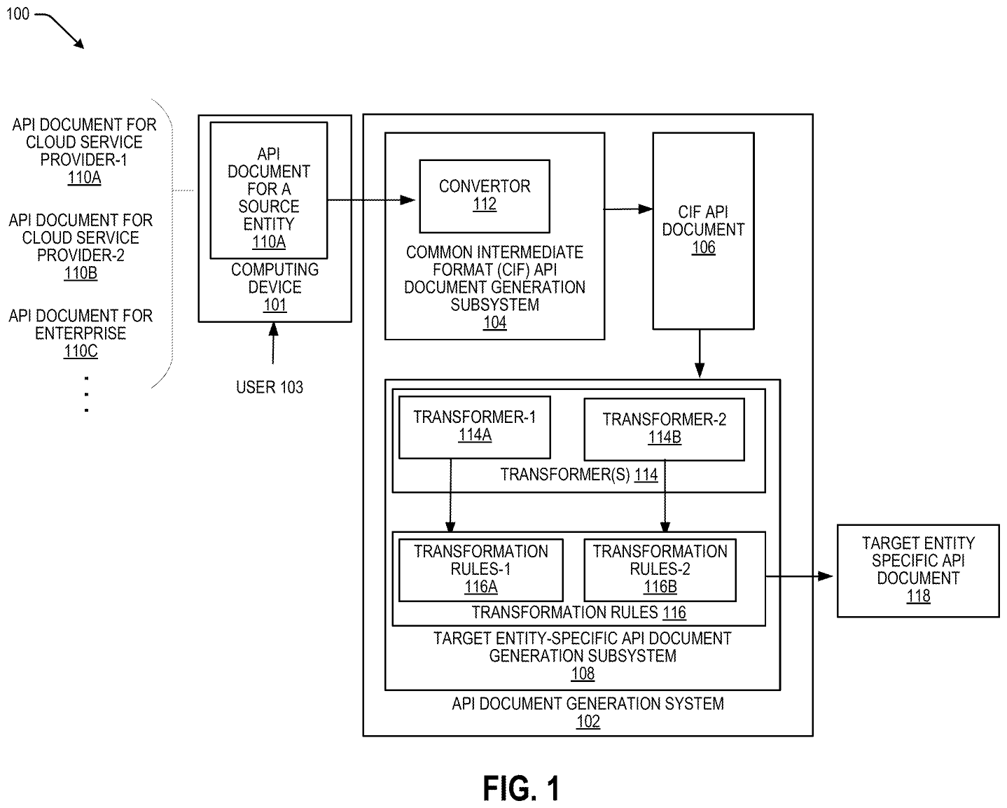

Referring now to the drawings, FIG. 1 depicts a high level diagram of a computing environment 100 including an API document generation system that includes capabilities for generating a target entity-specific Application Programing Interface (API) document as described herein, according to certain embodiments. The API document generation system 102 may be implemented by one or more computing systems. For example, the one or more computing systems may execute computer-readable instructions (e.g., code, program) to implement the API document generation system 102. The systems and subsystems depicted in FIG. 1 may be implemented using only software (e.g., code, instructions, program) executed by one or more processing units (e.g., processors, cores) of a computing system, hardware, or combinations thereof. The software may be stored on a non-transitory storage medium (e.g., on a memory device). Computing environment 100 depicted in FIG. 1 is merely an example and is not intended to unduly limit the scope of claimed embodiments. One of ordinary skill in the art would recognize many possible variations, alternatives, and modifications. For example, in some implementations, the API document generation system 102 can be implemented using more or fewer subsystems than those shown in FIG. 1, may combine two or more subsystems, or may have a different configuration or arrangement of subsystems.

The API document generation system 102 may be implemented in various different configurations. In certain embodiments, the API document generation system 102 may be implemented within an enterprise (e.g., an organization) servicing users of the enterprise. For instance, users of an enterprise may utilize the functionality of the API document generation system 102 to generate a target entity-specific API document for a target entity (in this case, the enterprise itself) based on an API document associated with a source entity. In some other embodiments, the system 102 may be implemented on one or more servers of a cloud service provider (CSP) and its API document generation functionality may be provided to subscribers (e.g., another enterprise or another CSP) who subscribe to cloud services on a subscription basis. A CSP, as described herein, may represent an entity that provides scalable computing resources that can be accessed by subscribers on demand over a network, such as compute and storage resources and applications.

In the embodiment depicted in FIG. 1, a user 103 may interact with the API document generation system 102 by providing the system 102 with an API document for analysis. The API document (e.g., 110A, 110B or 110C) may represent an API document that is associated with a particular source entity. The source entity may represent a company (e.g., an enterprise) or a cloud service provider. Different source entities may have different API documents (e.g., API document 110A, 110B, 110C and so on) for describing their APIs. For instance, in the embodiment shown in FIG. 1, the API document that is provided to the API document generation system 102 for analysis may represent an API document 110A that is associated with a particular CSP (CSP-1). Examples of API documents associated with a source entity may include, for instance, Software Development Kit (SDKs), Google® discovery documents, and so on. The API document 110A may comprise information such as the API description, a collection of resources utilized by services provided by the source entity along with the API operations associated with the resources, a list of available parameters for each operation, available parameter values associated with each operation, resource schemas, authentication information for the API, and so on.

In certain examples, the user 103 may interact with the system 102 using a computing device 101 that is communicatively coupled to the system 102, possibly, via one or more communication networks. The computing device may be of various types, including but not limited to, a mobile phone, a tablet, a desktop computer, and the like. The user may represent an end-user or an administrator of the system 102. In certain examples, the user may represent a customer (i.e., a target entity) of the system 102 who wishes to utilize the services provided by the system 102 to generate a target entity-specific API document. For instance, the system 102 may be implemented on one or more servers of a cloud service provider (CSP) and its target entity-specific API document functionality may be provided to a customer of the CSP on a subscription basis.

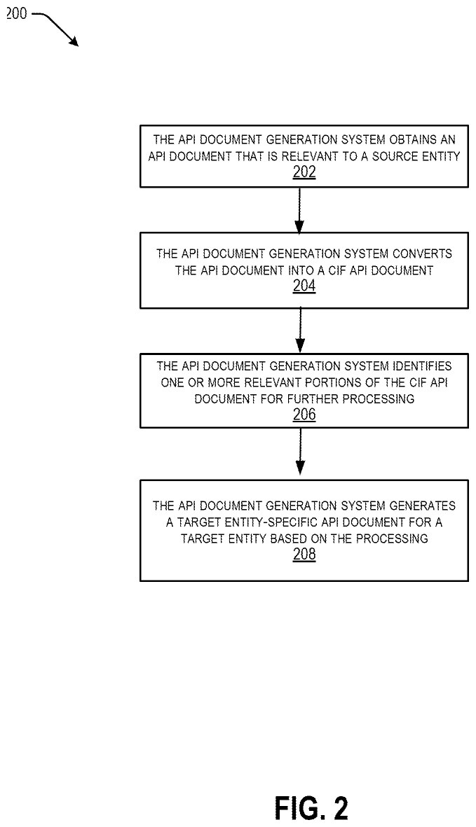

The user may interact with the system 102 using an application (e.g., a browser) executed by the user device. For example, the user may, via a UI of the application, provide an API document (e.g., 110A) to the API document generation system for analysis. The API document is then communicated from the computing device 101 to the system 102 for analysis. Upon receiving the request from the computing device 101, the API document generation system 102 performs processing to generate a target entity-specific API document for a target entity based on the API document (e.g., 110A) associated with a particular source entity. In certain embodiments, the processing performed by the API document generation system 102 comprises first converting the API document associated with the particular source entity into a common interface format (CIF) API document. The processing then includes modifying the CIF API document using a set of transformation rules to generate a target entity-specific API document that is compliant to a particular target entity. The results of the processing performed by the API document generation system 102 are then communicated back to the requesting user at the computing device 101. The results may include the target entity-specific API document 118, and possibly other information included in the results. The results may be output to the user via a UI of the computing device. Details related to the processing performed by the various systems and subsystems in FIG. 1 for generating a target entity-specific API document are described below with respect to the flowchart depicted in FIG. 2 and the accompanying description.

FIG. 2 depicts an example of a process 200 for generating a target entity-specific API document, according to certain embodiments. The processing depicted in FIG. 2 may be implemented in software (e.g., code, instructions, program) executed by one or more processing units (e.g., processors, cores) of the respective systems, hardware, or combinations thereof. The software may be stored on a non-transitory storage medium (e.g., on a memory device). The process 200 presented in FIG. 2 and described below is intended to be illustrative and non-limiting. Although FIG. 2 depicts the various processing steps occurring in a particular sequence or order, this is not intended to be limiting. In certain alternative embodiments, the steps may be performed in some different order, or some steps may also be performed in parallel. In certain embodiments, such as in the embodiment depicted in FIG. 1, the processing depicted in FIG. 2 may be performed by the CIF API document generation subsystem 104 and the target entity-specific API document generation subsystem 108 within the API document generation system 102.

The processing depicted in FIG. 2 may be initiated when, at block 202, the CIF API document generation subsystem 104 obtains an API document (e.g., 110A) that is relevant to a source entity for processing. As previously described, the API document 110A comprises information such as the API description, a collection of resources utilized by services provided by the source entity along with the API operations associated with the resources, a list of available parameters for each operation, available parameter values associated with each operation, resource schemas, authentication information for the API, and so on.

At block 204, the CIF API document generation subsystem 104 processes the API document 110A. The processing performed by the CIF API document generation subsystem 104 involves transforming/converting the API document 110A that is in a format specific to the source entity into a common intermediate format (CIF) API document 106. In a certain implementation, the CIF API document generation subsystem 104 comprises a convertor 112 that includes capabilities for transforming/converting the API document 110A into a CIF API document 106 by creating API definitions for describing the elements of the API document associated with the source entity in a clear and concise manner. In a certain implementation, the API definitions are described using interactive API documentation that is provided using a standard API description format (e.g., the OpenAPI Specification) that describes the set of components of the API document 110A in a clear and concise manner in the CIF API document. In other implementations, other types of API description formats may be used to provide interactive API documentation to generate a CIF API document.

The convertor 112 may be implemented using software (e.g., code, instructions, program) executed by one or more processing units (e.g., processors, cores), hardware, or combinations thereof. In a certain implementation, the convertor 112 may include a browser-based editor that provides an interface to write API definitions and create interactive APIs that are easily comprehensible for developers and non-technical end users using the OpenAI specification, a User Interface that renders the OpenAI specification as interactive API documentation for all the components of the API and a code generator that generates client libraries and basic code for creating API definitions for describing the elements of the API document using the OpenAI specification in a clear and concise manner.

The CIF API document 106 that is generated as a result of the processing performed by the CIF API document generation subsystem 104 comprises a detailed description of the elements within the API document 110. As previously described, the elements may be described using interactive API documentation (e.g., the OpenAPI specification). The elements may include, but are not limited to, path (endpoint) information associated with one or more resources used by the API, the operations applied to the resources, the input and output parameters for each operation, the authentication mechanisms needed by the API and other non-API related information (such as terms, contact information and license information) to use the API. The CIF API document generation subsystem 104 then transmits the CIF API document 106 to the target entity-specific API document generation subsystem 108 for further processing.

At block 206, the target entity-specific API document generation subsystem 108 identifies one or more relevant portions of the CIF API document for further processing. In one implementation, the subsystem 108 applies a filtering operation to the CIF API document 106 to identify the relevant portions within the CIF API document 106. In certain examples, a relevant portion identifies a resource defined in the CIF API document that is relevant to the target entity-specific API document being generated. The relevant portion may also include additional information associated with the resource. Information associated with a resource may include, for instance, path (endpoint) information used to access the resource, various operations applied to the resource, the input and output parameters for each operation, the output schema for a response body of each operation, and so on.

In certain examples, the filtering operation that is applied by the subsystem 108 may identify multiple resources in the CIF API document that meet a certain filtering criterion. For instance, the filtering criterion may specify that only resources of a particular resource type (e.g., instances, databases) that are relevant to the particular target entity (i.e., target entity-1) should be selected and all other resource types should be filtered out. In certain embodiments, the filtering operation not only removes resources that are not applicable to the target entity, but also recursively removes all dependent resources that will not be used in the target entity-specific API document.

In certain instances, the filtering operation that is applied to the CIF API document also results in the selection of one or more generic portions in the CIF API document. The generic portions may include API components such as header information, authentication information, registration information, and other non-related API information that may automatically be added/selected as one or more relevant portions of the CIF API document for further processing.

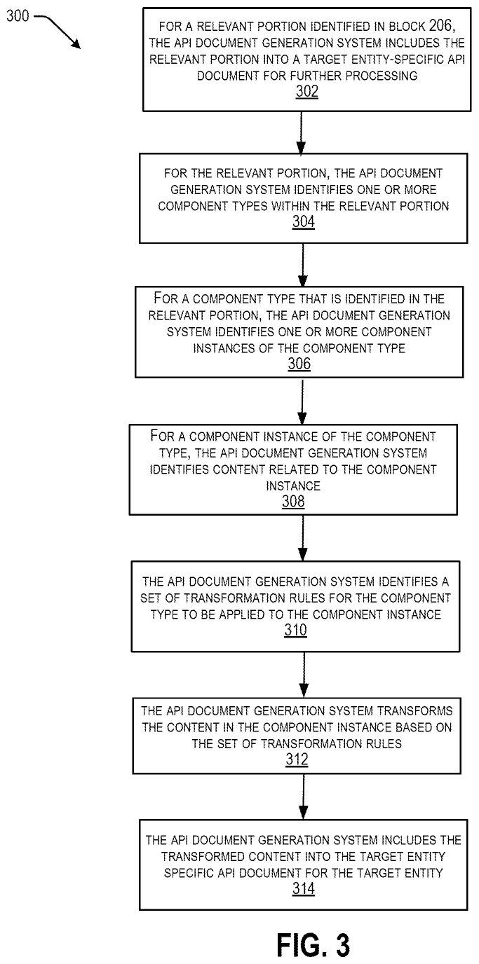

At block 208, the subsystem 108 processes the one or more identified relevant portions to generate a target entity-specific API document for a target entity. Additional details related to the processing performed by the subsystem 108 to generate a target entity-specific API document is described in FIG. 3.

FIG. 3 depicts an example of a process 300 for generating a target entity-specific API document, according to certain embodiments. The processing depicted in FIG. 3 may be implemented in software (e.g., code, instructions, program) executed by one or more processing units (e.g., processors, cores) of the respective systems, hardware, or combinations thereof. The software may be stored on a non-transitory storage medium (e.g., on a memory device). The process 300 presented in FIG. 3 and described below is intended to be illustrative and non-limiting. Although FIG. 3 depicts the various processing steps occurring in a particular sequence or order, this is not intended to be limiting. In certain alternative embodiments, the steps may be performed in some different order, or some steps may also be performed in parallel. In certain embodiments, such as in the embodiment depicted in FIG. 1, the processing depicted in FIG. 3 may be performed by the target entity-specific API document generation subsystem 108 within the API document generation system 102. The processing described in FIG. 3 describes additional details of the processing performed by the API document generation system in block 208 of FIG. 2.

At block 302, for a relevant portion (identified in block 206), the subsystem 108 includes the relevant portion of the CIF API document 106 into a target entity-specific API document for further processing. For the processing depicted in 302 in FIG. 3, it is assumed that the target entity-specific API document is being built/generated by the subsystem 108 from scratch (e.g., the target entity-specific API document is empty to start out with).

At block 304, for the relevant portion, the subsystem 108 identifies one or more component types within the relevant portion. As previously described, in certain cases, a relevant portion of the CIF API document may identify a resource (e.g., an instance or a database) defined in the CIF API document that is relevant to the target entity-specific API document being generated. The component types in a relevant portion (e.g., a resource) may represent various types of operations (also referred to herein as operation types) that may be applied to the resource. The operation types represent additional information associated with the resource and are used to describe what is to be done with the resource. The various operation types may include, but are not limited to, a POST operation type that is used to create or update a resource, a GET operation type is used to retrieve a resource, a PUT operation type is used to update a resource, a DELETE operation type is used to delete a resource and so on. In other cases, as previously described, a relevant portion identified by the subsystem 108 may also correspond to a generic portion of the CIF document such as authentication information needed by the API and other non-API related information (such as terms, contact information, registration information, and license to use the API).

At block 306, for the component type that is identified within the relevant portion, the subsystem 108 identifies one or more component instances of the component type. For instance, a component type that is identified in a relevant portion may correspond to a POST operation type that is applied to the resource. The component instances identified for the POST operation type may correspond to one or more POST operation instances that may be identified within the relevant portion of the CIF API document. For instance, a first POST operation instance may be used to perform a first operation to create a database resource and second POST operation instance may be used to perform a second operation to add a child resource to the database resource.

At block 308, for the component instance of the component type identified in block 306, the subsystem 108 identifies content related to the component instance that is included in the relevant portion. For instance, the content related to a POST operation instance may include additional information associated with the resource such as the path (endpoint) information used to access the resource, a description of the operation type, an operation identifier that is an optional unique string used to identify the operation type, the input parameters used by the operation type and the output parameters used by the operation type, the response schema associated with the operation type and so on. The content for the operation type may also include additional optional elements for documentation purposes such as a summary of what the operation does and tags that are used to group the operation logically by one or more resources and so on.

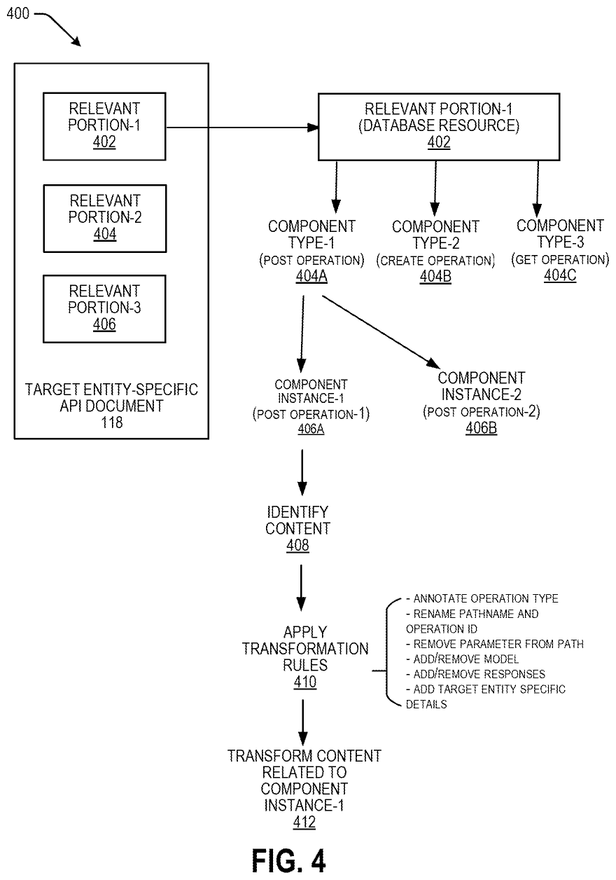

At block 310, the subsystem 108 identifies a set of transformation rules for the component type to be applied to the component instance. In one implementation, the subsystem 108 may utilize one or more transformer(s) 114 (shown in FIG. 1) to identify a set of transformation rules to be applied to a component instance of a component type that is identified in a relevant portion of the CIF API document. The set of transformation rules (116A or 116B) that are identified by the transformers (114A or 114B) are relevant to the target entity-specific API document is being generated. For instance, if a target entity-specific API document is being generated for a target entity-1, then a transformer (e.g., 114A) may be used to identify a set of transformation rules (e.g., 116A) to be applied to a component instance of a particular component type. If a target entity-specific API document is being generated for a different target entity-2, then a different transformer (e.g., 114B) may be used to identify a set of transformation rules (e.g., 116B) to be applied to a component instance of a particular component type. The transformer(s) 114A, 114B may be implemented using software (e.g., code, instructions, program) executed by one or more processing units (e.g., processors, cores), hardware, or combinations thereof. An example of a set of transformation rules that can be applied to a component instance of a component type identified in a relevant portion of a CIF API document are further described in relation to the example shown in FIG. 4.

In block 312, the subsystem 108 transforms the content in the component instance based on the set of transformation rules. Examples of transformed content in a component instance identified in a relevant portion using transformation rules are described in detail in relation to the example shown in FIG. 4.

In block 314, the subsystem 108 includes the transformed content associated with the component instance into the target entity-specific API document for the target entity.

FIG. 4 illustrates an example of a target entity-specific API document for a target entity that is generated by processing one or more relevant portions from a CIF API document, according to certain embodiments. In the illustrated example, one or more relevant portions 402, 404, and 406 within a CIF API document (e.g., 106) may be extracted/identified by the subsystem 108 shown in FIG. 1 for further processing. For purposes of describing this example, the first relevant portion 402 may correspond to a first resource (e.g., a “database” resource) defined in the CIF API document that is relevant to the target entity-specific API document being generated, the second relevant portion 404 may correspond to a different resource (e.g., an “instance” resource) in the CIF API document that is also relevant to the target entity-specific API document being generated and the third relevant portion 406 may correspond to a generic portion (e.g., API authentication information) in the CIF API document that is automatically identified and extracted by the subsystem 108 for further processing. The target entity-specific API document generated by the subsystem 108 based on processing the relevant portions extracted from a CIF API document illustrated in FIG. 4 is just one example of a target entity-specific API document generated by the subsystem 108. In other examples, the subsystem 108 may generate a different target entity-specific API document that includes more or fewer numbers of relevant portions that describe more or fewer component types and component instances within each relevant portion.

The subsystem 108 then processes each relevant portion to generate the target entity-specific API document for the target entity. As described in FIG. 3, the processing performed by the subsystem 108 for each relevant portion first involves, identifying one or more component types within the relevant portion. An example of one or more component types (404A, 404B and 404C) identified in a relevant portion 402 is further illustrated in FIG. 4. For example, as previously described, a relevant portion 402 may correspond to a type of resource (e.g., a database resource) that is identified from the CIF API document. The first component type 404A may correspond to a POST operation type that is applied to the database resource, the second component type 404B may correspond to a CREATE operation type that is applied to the database resource and the component type 404C may correspond to a GET operation type that is applied to the resource.

Upon identifying the component types within a relevant portion, the processing performed by the subsystem 108 further involves identifying one or more component instances for each component type. An example of one or more component instances (406A, 406B) identified for a component type 404A is illustrated in FIG. 4. For the example of the POST operation type described above, a first component instance (406A) may correspond to a first POST operation that is applied to the resource and a second component instance (406B) may correspond to a second POST operation that may be applied to the resource.

The processing performed by the subsystem 108 then involves identifying content 408 associated with each identified component instance. In certain examples, the content that is identified for a component instance that is of a POST operation type may include for instance, the POST operation type itself, a description of the POST operation, an operation identifier that is an optional unique string used to identify the POST operation, the path information used to access the resource, the input parameters used by the POST operation, the output parameters used by the POST operation, the output schema for a response body of the operation and so on. The content for the POST operation type may also comprise additional optional elements for documentation purposes such as a summary of what the operation does and tags that are used to group the operation logically by one or more resources and so on.

The subsystem 108 then identifies a set of transformation rules 410 to be applied to the component instance. The set of transformation rules 410 may be identified and applied to the component instance by a transformer (e.g., 114A) implemented within the subsystem 108. The subsystem 108 transforms the content in the component instance based on the set of transformation rules and then includes the transformed content in the target entity-specific API document. In certain examples, the set of transformation rules 410 may represent multiple rules that are applied sequentially to the content of a component instance identified in a relevant portion of the CIF API document. In other examples, the set of transformation rules 410 may represent multiple rules that may be identified and executed in parallel, or an overlapping manner by the transformer to the content of a component instance that is identified in a relevant portion of the CIF API document.

The illustration shown in FIG. 4 depicts an exemplary set of transformation rules 410 that may be identified and applied to a component instance (e.g., 406A) of a component type 404A in a relevant portion 402 identified from a CIF API document. In this example, the set of transformation rules 410 represent multiple transformation rules that may be applied sequentially to the component instance. Each transformation rule transforms a portion of the content (also referred to herein as original content) associated with the component instance to generate a corresponding portion of transformed content associated with the component instance. The transformed content describes the content of the component instance in accordance with the format and rules specified by the target entity. In certain examples, the transformed content may additionally include code/code artifacts that describe the content of the component instance in accordance with the format and rules specified by the target entity.

For example, in one implementation, a first transformation rule in the set of transformation rules 410 may transform the API operation type (i.e., a portion of the original content) associated with a component instance by annotating the API operation type with additional semantic information. The application of the first transformation rule may involve, for instance, classifying the API operation type into a particular group from a pre-defined set of groups and then annotating the operation type with semantic information associated with the particular group. The pre-defined set of groups may correspond to various operation types that describe what is to be done with the resource. For instance, the pre-defined set of groups may include, but are not limited to, a GET resource group, a CREATE resource group, an UPDATE resource group, a DELETE resource group, a LIST resource group and an ACTION group. For instance, the first transformation rule may transform the API operation type (i.e., a portion of the original content) of a GET component instance by classifying the instance into a particular group (GET resource group), annotating the group with additional semantic information that is in a format specified by the target entity, and renaming the API operation type into a format/standard specified by the target entity.

A second transformation rule in the set of transformation rules 410 may transform/modify the operation's path information (another portion of the original content of a component instance) to remove specific details (e.g., parameter information) related to the source entity. A portion of the original content of a component instance (e.g., GET component instance) that is identified in a relevant portion (e.g., 402) is shown below. The portion of the original content includes information that identifies the pathname as well as the operation identifier associated with a database resource as shown below:

/v1/projects/{projectsId}/instances/{instancesId}/databases/{databasesId}:
..................................
operationId: spanner.projects.instances.databases.get
/v1/projects/{projectsId}/instances/{instancesId}:testIamPermissions:
.................................
operationId: spanner.projects.instances.testIamPermissions

A portion of the transformed content that is generated by the subsystem 108 as a result of applying the first transformation rule and the second transformation rule is shown below:

/instances/{instancesId}/databases/{databasesId}:
........................................
operationId: GetDatabases
/instances/{instancesId}/actions/testIamPermissions:
........................................
operationId: InstancesTestIamPermissions

As shown above, the portion of the original content comprising the operation identifier, “operationId: spanner.projects.instances.databases.get,” is modified/transformed to “operationId: GetDatabases,” as a result of applying the first transformation rule. A portion of the original content comprising the pathname information used to access the resource, “/v1/projects/{projectsId}/instances/{instancesId}/databases/{databasesId}:,” is modified to “/instances/{instancesId}/databases/{databasesId}:,” as a result of applying the second transformation rule. Similarly, the portion of the original content comprising the operation identifier, “operationId: spanner.projects.instances.testlamPermissions,” is modified/transformed to “operationId: InstancesTestIamPermissions,” and the portion of the original content comprising the pathname information used to access the resource, “/v1/projects/{projectsId}/instances/{instancesId}: testlamPermissions:,” is modified/transformed to “/instances/{instancesId}/actions/testIamPermissions:.”

In certain instances, one or more additional transformation rules may be applied to other portions of the original content of a component instance. For instance, a third transformation rule may be applied to first remove a data model in a portion of the original content of a relevant portion that is not aligned with the target entity and then add a data model that is aligned to the target entity as transformed content associated with the component instance in the relevant portion of the target entity-specific API document. A portion of the original content that includes information that identifies a data model in a component instance in a relevant portion (e.g., 402) that is not aligned to the target entity is shown below.

/v1/projects/{projectsId}/instances:
parameters:
- in: body
name: RequestParam
required: false
schema:
$ref: ‘#/definitions/CreateInstanceRequest’

The transformed content that is generated by the subsystem 108 as a result of applying this transformation rule is shown below:

/instances:
parameters:
- in: body
name: CreateInstancesDetails
required: false
schema:
$ref: ‘#/definitions/

As may be observed, based on this transformation rule, the CreateInstanceRequest model that is part of the original content in the relevant portion is replaced with a new model, CreateInstanceDetails. In certain examples, as a result of applying this transformation rule, additional information that describes details of the new model is also added by the subsystem 108. The additional information associated with the new model is added to the relevant portion in the target entity-specific API document by the subsystem 108 as part of the transformed content in the relevant portion. An example of the details associated with the new model is illustrated below. The details that are added include, for instance, the type the data model, the compartment identifier, a description of the functionality provided by the data model and so on.

CreateInstancesDetails:
type: object
required:
- compartmentId
properties:
instanceId:
type: string
description: ″Required. The ID of the instance to create. Valid identifiers\
\ are of the form ‘a-z*[a-z0-9]‘ and must be between 2 and 64 characters\
\ in length.″
instance:
description: ″Required. The instance to create. The name may be omitted, but\
\ if specified must be ‘/instances/‘.″
$ref: ′#/definitions/Instance′
compartmentId:
type: string
description: ″The [ID](/iaas/Content/General/Concepts/identifiers.htm) of\
\ the compartment to create the service connector in.″
minLength: 1
maxLength: 255
description: The request for CreateInstance.

Another example of a transformation rule that may be applied to the content of a component instance within a relevant portion may involve removing an API response that is not aligned with the target entity and adding an API response that is aligned to the target entity to the relevant portion of the target entity-specific API document. A portion of the original content that includes an API response in a relevant portion (e.g., 402) that is not aligned to the target entity is shown below:

/v1/projects/{projectsId}/instances:
responses:
“200”:
description: Successful response
schema:
$ref: ‘#/definitions/ListInstancesResponse’

The transformed content that is generated by the subsystem 108 as a result of applying this transformation rule is shown below:

/instances:
responses:
“200”:
description: Successful response
headers:
opc-request-id:
type: string
description: opc-request-id
opc-next-page:
type: string
description: opc-next-page
schema:
$ref: ‘#/definitions/ListInstancesResponse’
“400”:
$ref: ‘#/responses/400’
“401”:
$ref: ‘#/responses/401’
“404”:
$ref: ‘#/responses/404’
“429”:
$ref: ‘#/responses/429’
“500”:
$ref: ‘#/responses/500’
default:
$ref: ‘#/responses/default’

In certain cases, as previously described, a relevant portion (e.g., 406) identified by the subsystem 108 may also correspond to a generic portion of the CIF API document such as authentication information needed by the API and other non-API related information (such as terms, contact information, registration information, and license to use the API. The subsystem 108 may process a relevant portion identified in the CIF API document that corresponds to a generic portion in a similar manner as the processing described above for a relevant portion of the CIF document that identifies a resource that is relevant to the target entity. To process a relevant portion that comprises generic information related to the API, the subsystem 108 may first identify a component type within the relevant portion. An example of a component type in a generic portion may include registration information to use the API. The subsystem may then identify a transformation rule to be applied to transform the registration information into a format that is suitable with and aligned to the target entity. An example of transformed content that is generated by the subsystem 108 as a result of applying a transformation rule to the registration information for registering a service (splat) within a relevant portion is shown below:

/instances:
x-obmcs-splat:
allowAllRequestHeaders: true
routing:
strategy: route-to-any-ad
serviceList:
- spannerService
resources:
instances:
actionKind: READ
serviceResourceName: instances
targetCompartmentId: request.parameter.compartmentId
permissions: “[‘INSTANCES_READ’]”
authorization:
mode: automated
check: “resources[‘instances'].grantedPermissions.contains(‘INSTANCES_READ’)”
audit:
mode: automated

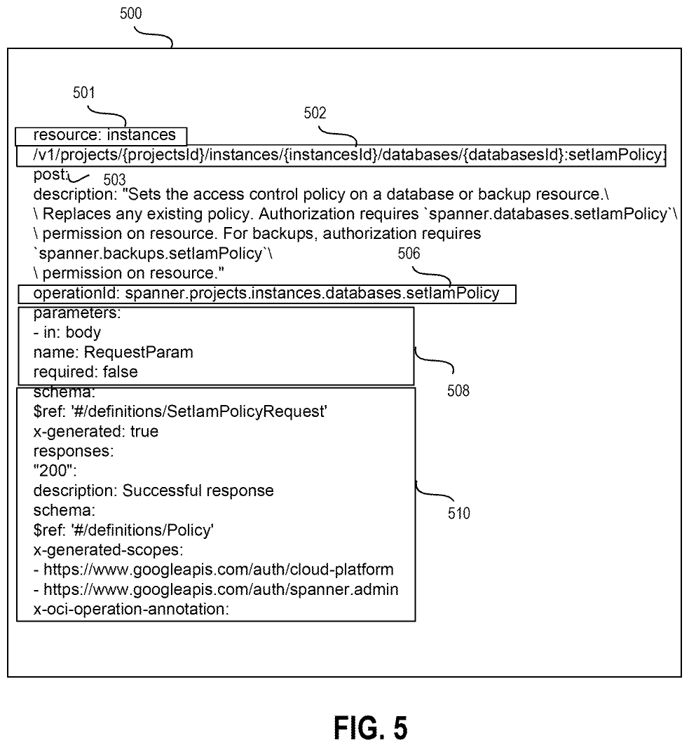

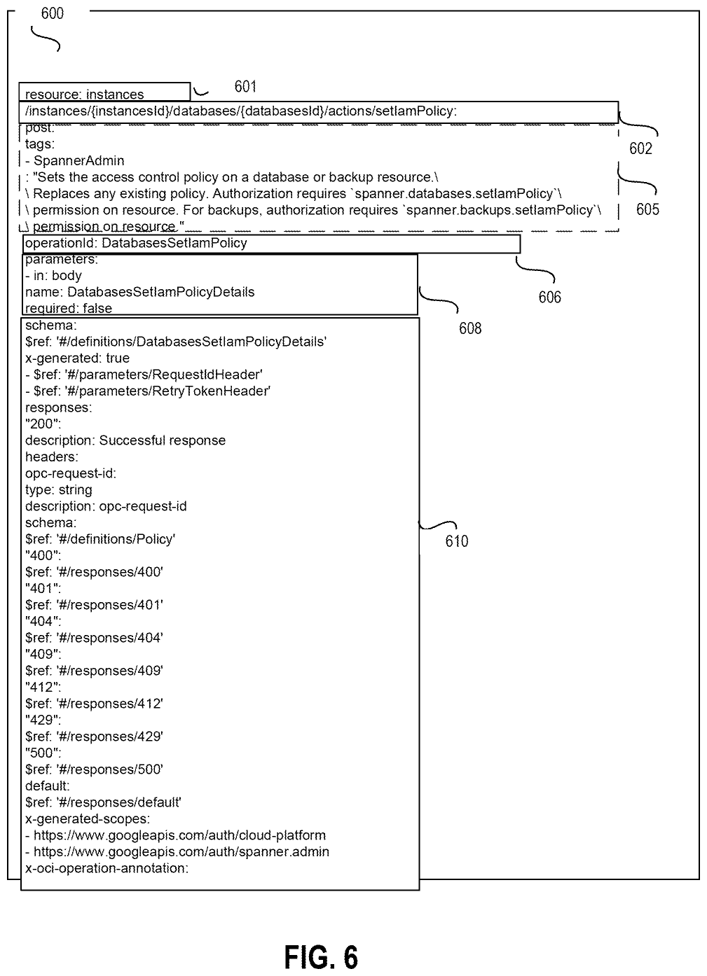

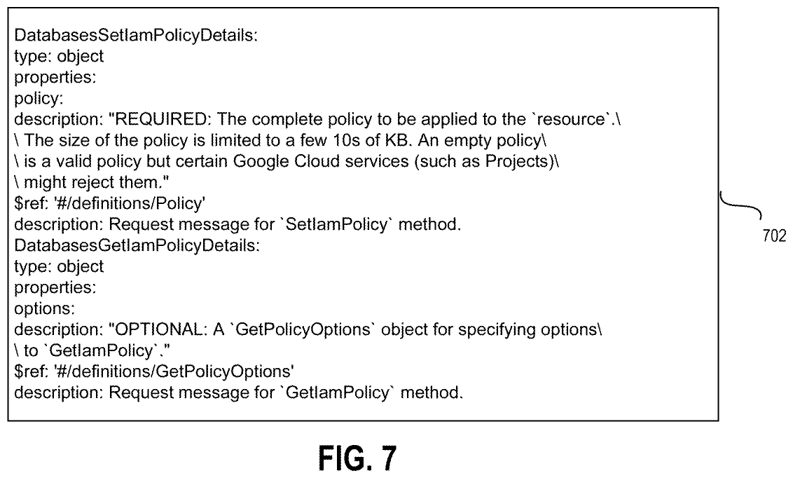

In certain embodiments, in addition to the set of transformation rules described in FIG. 4, the subsystem 108 may identify other types of transformation rules that can be applied to portions of the content associated with a component instance that is identified in a relevant portion. The additional types of transformations as well as the transformed content that is generated as a result of applying these transformations are described in the examples depicted in FIG. 5, FIG. 6, and FIG. 7 below.

FIG. 5 depicts an example of original content associated with a component instance in a relevant portion that is identified from a CIF API document for further processing, according to certain embodiments. As previously described, a relevant portion may be identified by the subsystem 108 depicted in FIG. 1 from a CIF API document. In the example shown in FIG. 5, the original content 500 in a relevant portion identifies a resource 501 (e.g., an instance) defined in the CIF API document that is relevant to the target entity-specific API document being generated. While the relevant portion identifies a single resource identified by the subsystem 108 as a result of applying a filtering operation to the CIF API document, in alternate embodiments, the subsystem 108 may identify multiple resources (i.e., multiple relevant portions) within the CIF API document that are relevant to a particular target entity.

As further depicted in FIG. 5, the original content 500 in the relevant portion identifies a component instance of a component type (i.e., a POST operation type) 503 that describes what is to be done with the instance resource. The original content related to the POST component instance comprises additional information associated with the resource such as the path (endpoint) information 502 used to access the resource, the operation identifier 506 that is an optional unique string used to identify the POST operation type, the input parameters 508 used by the operation type and the response schema 510 associated with the operation type. The subsystem 108 then identifies a set of transformation rules to be applied to the original content of the component instance. The subsystem 108 transforms the content in the component instance based on the set of transformation rules and then includes the transformed content in the target entity-specific API document as depicted in FIG. 6.

FIG. 6 depicts an example of transformed content 600 associated with a component instance that generated for a relevant portion of a target entity-specific API document, according to certain embodiments. The transformed content is generated by applying a set of transformation rules to the original content associated with the component instance in the relevant portion. Each transformation rule transforms a portion of the original content associated with the component instance to generate a corresponding portion of transformed content associated with the component instance. The transformed content describes the content of the component instance in accordance with the format and rules specified by the target entity. As previously described, the transformed content may additionally include code/code artifacts that describe the content of the component instance in accordance with the format and rules specified by the target entity.

In the embodiment depicted in FIG. 6, the transformed content 600 in the relevant portion comprises one or more portions (602, 605, 606, 608 and 610) of transformed content, where each portion of the transformed content is generated by transforming a corresponding portion of the original content of the component instance shown in FIG. 5 using a particular transformation rule. For instance, the transformed portion 602 in the transformed content 600 identifies modified path (endpoint) information used to access the resource 601. The transformed portion 602 is generated by applying a transformation rule that transforms the pathname information identified in a particular portion 502 of the original content 500 associated with a component instance. Similarly, the transformed portion 606 in the transformed content 600 identifies modified operator identifier information associated with the resource 601. The transformed portion 606 is generated by applying a transformation rule that transforms the operator identifier information identified in a corresponding particular portion 506 of the original content 500 associated with a component instance.

The transformed portion 608 identifies modified model information associated with the resource 601. The transformed portion 608 is generated by applying a transformation rule that transforms the model information identified in a corresponding original portion 508 of the original content 500 associated with a component instance. As may be observed, based on this transformation rule, the RequestParam model that is part of the original portion 508 of the original content 500 is replaced with a new model, DatabaseSetIamPolicyDetails. In certain examples, as a result of applying this transformation rule, additional information that describes details of the new model are also added by the subsystem 108. The additional information associated with the new model is added to the relevant portion in the target entity-specific API document by the subsystem 108 as part of the transformed content in the relevant portion as illustrated in FIG. 7.

In certain instances, as depicted in the examples shown in FIG. 5 and FIG. 6, certain portions of the original content associated with a component instance may be optionally modified using a transformation rule. For instance, the description of the operator type (e.g., POST operation) may be modified using a transformation rule and the modified content may be included in a corresponding portion 605 of the transformed content in the relevant portion as illustrated in FIG. 6.

FIG. 7 depicts an example of the details associated with a new model generated by the system and included as transformed content in a target entity-specific API document, in accordance with certain embodiments. The new model is generated by the subsystem 108 shown in FIG. 4 a result of applying a transformation rule to the original content associated with the component instance. As shown in FIG. 7, the details associated with the new model may include, for instance, the type the data model, the model properties, the policy implemented by the model, a description of the model and so on. The details associated with the new model depicted in FIG. 7 is just one example of a new model that is generated by the subsystem 108. In other examples, the subsystem 108 may generate a model with a different set of parameters that include more or fewer numbers of parameters that describe the details of the model.

The target entity-specific API document generated by the disclosed system can be utilized by a target entity to build services for its end users/customers in a cost-effective manner without having to create new libraries or tools for the new service from scratch. Additionally, since the target entity-specific API document is generated is in a format that is compatible with the API design requirements of the target entity, it can directly be used in services developed by the target entity without requiring to be manually updated to the format and specifications required by the target entity. This results in the ability for the target entity to create and develop new services and/or modify existing services in a cost-effective and timely manner.

Infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (e.g., billing, monitoring, logging, load balancing and clustering, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

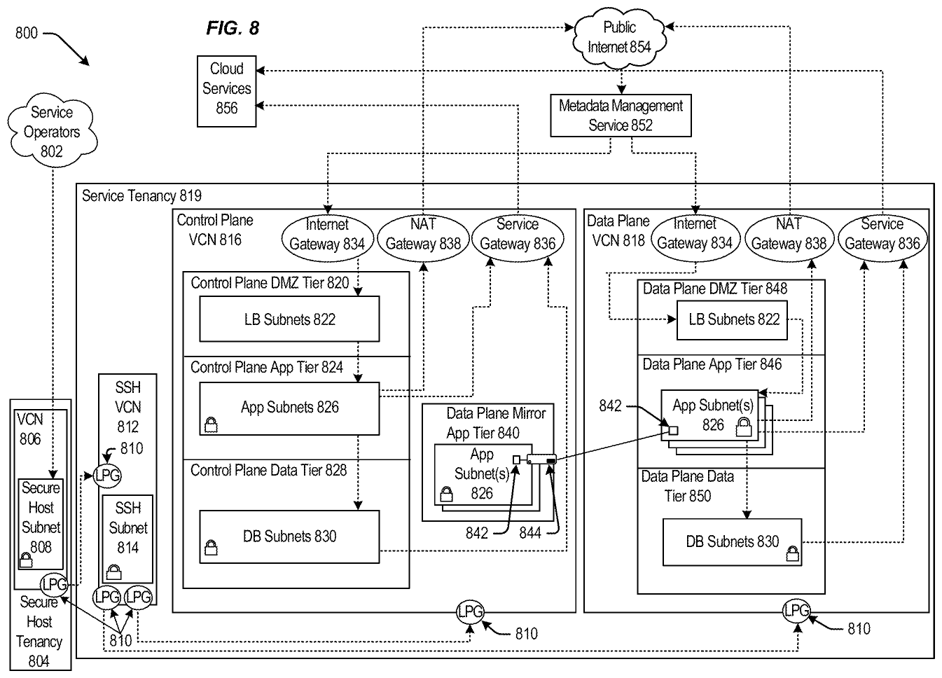

FIG. 8 is a block diagram 800 illustrating an example pattern of an IaaS architecture, according to at least one embodiment. Service operators 802 can be communicatively coupled to a secure host tenancy 804 that can include a virtual cloud network (VCN) 806 and a secure host subnet 808. In some examples, the service operators 802 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 806 and/or the Internet.

The VCN 806 can include a local peering gateway (LPG) 810 that can be communicatively coupled to a secure shell (SSH) VCN 812 via an LPG 810 contained in the SSH VCN 812. The SSH VCN 812 can include an SSH subnet 814, and the SSH VCN 812 can be communicatively coupled to a control plane VCN 816 via the LPG 810 contained in the control plane VCN 816. Also, the SSH VCN 812 can be communicatively coupled to a data plane VCN 818 via an LPG 810. The control plane VCN 816 and the data plane VCN 818 can be contained in a service tenancy 819 that can be owned and/or operated by the IaaS provider.

The control plane VCN 816 can include a control plane demilitarized zone (DMZ) tier 820 that acts as a perimeter network (e.g., portions of a corporate network between the corporate intranet and external networks). The DMZ-based servers may have restricted responsibilities and help keep breaches contained. Additionally, the DMZ tier 820 can include one or more load balancer (LB) subnet(s) 822, a control plane app tier 824 that can include app subnet(s) 826, a control plane data tier 828 that can include database (DB) subnet(s) 830 (e.g., frontend DB subnet(s) and/or backend DB subnet(s)). The LB subnet(s) 822 contained in the control plane DMZ tier 820 can be communicatively coupled to the app subnet(s) 826 contained in the control plane app tier 824 and an Internet gateway 834 that can be contained in the control plane VCN 816, and the app subnet(s) 826 can be communicatively coupled to the DB subnet(s) 830 contained in the control plane data tier 828 and a service gateway 836 and a network address translation (NAT) gateway 838. The control plane VCN 816 can include the service gateway 836 and the NAT gateway 838.

The control plane VCN 816 can include a data plane mirror app tier 840 that can include app subnet(s) 826. The app subnet(s) 826 contained in the data plane mirror app tier 840 can include a virtual network interface controller (VNIC) 842 that can execute a compute instance 844. The compute instance 844 can communicatively couple the app subnet(s) 826 of the data plane mirror app tier 840 to app subnet(s) 826 that can be contained in a data plane app tier 846.

The data plane VCN 818 can include the data plane app tier 846, a data plane DMZ tier 848, and a data plane data tier 850. The data plane DMZ tier 848 can include LB subnet(s) 822 that can be communicatively coupled to the app subnet(s) 826 of the data plane app tier 846 and the Internet gateway 834 of the data plane VCN 818. The app subnet(s) 826 can be communicatively coupled to the service gateway 836 of the data plane VCN 818 and the NAT gateway 838 of the data plane VCN 818. The data plane data tier 850 can also include the DB subnet(s) 830 that can be communicatively coupled to the app subnet(s) 826 of the data plane app tier 846.

The Internet gateway 834 of the control plane VCN 816 and of the data plane VCN 818 can be communicatively coupled to a metadata management service 852 that can be communicatively coupled to public Internet 854. Public Internet 854 can be communicatively coupled to the NAT gateway 838 of the control plane VCN 816 and of the data plane VCN 818. The service gateway 836 of the control plane VCN 816 and of the data plane VCN 818 can be communicatively couple to cloud services 856.

In some examples, the service gateway 836 of the control plane VCN 816 or of the data plane VCN 818 can make application programming interface (API) calls to cloud services 856 without going through public Internet 854. The API calls to cloud services 856 from the service gateway 836 can be one-way: the service gateway 836 can make API calls to cloud services 856, and cloud services 856 can send requested data to the service gateway 836. But, cloud services 856 may not initiate API calls to the service gateway 836.

In some examples, the secure host tenancy 804 can be directly connected to the service tenancy 819, which may be otherwise isolated. The secure host subnet 808 can communicate with the SSH subnet 814 through an LPG 810 that may enable two-way communication over an otherwise isolated system. Connecting the secure host subnet 808 to the SSH subnet 814 may give the secure host subnet 808 access to other entities within the service tenancy 819.

The control plane VCN 816 may allow users of the service tenancy 819 to set up or otherwise provision desired resources. Desired resources provisioned in the control plane VCN 816 may be deployed or otherwise used in the data plane VCN 818. In some examples, the control plane VCN 816 can be isolated from the data plane VCN 818, and the data plane mirror app tier 840 of the control plane VCN 816 can communicate with the data plane app tier 846 of the data plane VCN 818 via VNICs 842 that can be contained in the data plane mirror app tier 840 and the data plane app tier 846.

In some examples, users of the system, or customers, can make requests, for example create, read, update, or delete (CRUD) operations, through public Internet 854 that can communicate the requests to the metadata management service 852. The metadata management service 852 can communicate the request to the control plane VCN 816 through the Internet gateway 834. The request can be received by the LB subnet(s) 822 contained in the control plane DMZ tier 820. The LB subnet(s) 822 may determine that the request is valid, and in response to this determination, the LB subnet(s) 822 can transmit the request to app subnet(s) 826 contained in the control plane app tier 824. If the request is validated and requires a call to public Internet 854, the call to public Internet 854 may be transmitted to the NAT gateway 838 that can make the call to public Internet 854. Metadata that may be desired to be stored by the request can be stored in the DB subnet(s) 830.

In some examples, the data plane mirror app tier 840 can facilitate direct communication between the control plane VCN 816 and the data plane VCN 818. For example, changes, updates, or other suitable modifications to configuration may be desired to be applied to the resources contained in the data plane VCN 818. Via a VNIC 842, the control plane VCN 816 can directly communicate with, and can thereby execute the changes, updates, or other suitable modifications to configuration to, resources contained in the data plane VCN 818.

In some embodiments, the control plane VCN 816 and the data plane VCN 818 can be contained in the service tenancy 819. In this case, the user, or the customer, of the system may not own or operate either the control plane VCN 816 or the data plane VCN 818. Instead, the IaaS provider may own or operate the control plane VCN 816 and the data plane VCN 818, both of which may be contained in the service tenancy 819. This embodiment can enable isolation of networks that may prevent users or customers from interacting with other users′, or other customers′, resources. Also, this embodiment may allow users or customers of the system to store databases privately without needing to rely on public Internet 854, which may not have a desired level of threat prevention, for storage.

In other embodiments, the LB subnet(s) 822 contained in the control plane VCN 816 can be configured to receive a signal from the service gateway 836. In this embodiment, the control plane VCN 816 and the data plane VCN 818 may be configured to be called by a customer of the IaaS provider without calling public Internet 854. Customers of the IaaS provider may desire this embodiment since database(s) that the customers use may be controlled by the IaaS provider and may be stored on the service tenancy 819, which may be isolated from public Internet 854.

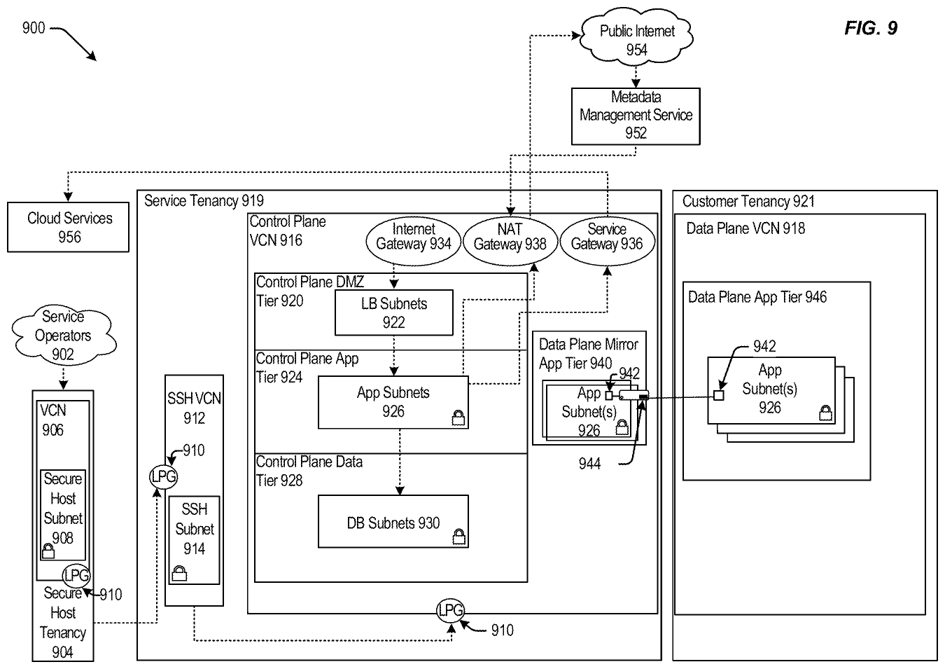

FIG. 9 is a block diagram 900 illustrating another example pattern of an IaaS architecture, according to at least one embodiment. Service operators 902 (e.g., service operators 802 of FIG. 8) can be communicatively coupled to a secure host tenancy 904 (e.g., the secure host tenancy 804 of FIG. 8) that can include a virtual cloud network (VCN) 906 (e.g., the VCN 806 of FIG. 8) and a secure host subnet 908 (e.g., the secure host subnet 808 of FIG. 8). The VCN 906 can include a local peering gateway (LPG) 910 (e.g., the LPG 810 of FIG. 8) that can be communicatively coupled to a secure shell (SSH) VCN 912 (e.g., the SSH VCN 812 of FIG. 8) via an LPG 810 contained in the SSH VCN 912. The SSH VCN 912 can include an SSH subnet 914 (e.g., the SSH subnet 814 of FIG. 8), and the SSH VCN 912 can be communicatively coupled to a control plane VCN 916 (e.g., the control plane VCN 816 of FIG. 8) via an LPG 910 contained in the control plane VCN 916. The control plane VCN 916 can be contained in a service tenancy 919 (e.g., the service tenancy 819 of FIG. 8), and the data plane VCN 918 (e.g., the data plane VCN 818 of FIG. 8) can be contained in a customer tenancy 921 that may be owned or operated by users, or customers, of the system.

The control plane VCN 916 can include a control plane DMZ tier 920 (e.g., the control plane DMZ tier 820 of FIG. 8) that can include LB subnet(s) 922 (e.g., LB subnet(s) 822 of FIG. 8), a control plane app tier 924 (e.g., the control plane app tier 824 of FIG. 8) that can include app subnet(s) 926 (e.g., app subnet(s) 826 of FIG. 8), a control plane data tier 928 (e.g., the control plane data tier 828 of FIG. 8) that can include database (DB) subnet(s) 930 (e.g., similar to DB subnet(s) 830 of FIG. 8). The LB subnet(s) 922 contained in the control plane DMZ tier 920 can be communicatively coupled to the app subnet(s) 926 contained in the control plane app tier 924 and an Internet gateway 934 (e.g., the Internet gateway 834 of FIG. 8) that can be contained in the control plane VCN 916, and the app subnet(s) 926 can be communicatively coupled to the DB subnet(s) 930 contained in the control plane data tier 928 and a service gateway 936 (e.g., the service gateway 836 of FIG. 8) and a network address translation (NAT) gateway 938 (e.g., the NAT gateway 838 of FIG. 8). The control plane VCN 916 can include the service gateway 936 and the NAT gateway 938.

The control plane VCN 916 can include a data plane mirror app tier 940 (e.g., the data plane mirror app tier 840 of FIG. 8) that can include app subnet(s) 926. The app subnet(s) 926 contained in the data plane mirror app tier 940 can include a virtual network interface controller (VNIC) 942 (e.g., the VNIC of 842) that can execute a compute instance 944 (e.g., similar to the compute instance 844 of FIG. 8). The compute instance 944 can facilitate communication between the app subnet(s) 926 of the data plane mirror app tier 940 and the app subnet(s) 926 that can be contained in a data plane app tier 946 (e.g., the data plane app tier 846 of FIG. 8) via the VNIC 942 contained in the data plane mirror app tier 940 and the VNIC 942 contained in the data plane app tier 946.

The Internet gateway 934 contained in the control plane VCN 916 can be communicatively coupled to a metadata management service 952 (e.g., the metadata management service 852 of FIG. 8) that can be communicatively coupled to public Internet 954 (e.g., public Internet 854 of FIG. 8). Public Internet 954 can be communicatively coupled to the NAT gateway 938 contained in the control plane VCN 916. The service gateway 936 contained in the control plane VCN 916 can be communicatively couple to cloud services 956 (e.g., cloud services 856 of FIG. 8).

In some examples, the data plane VCN 918 can be contained in the customer tenancy 921. In this case, the IaaS provider may provide the control plane VCN 916 for each customer, and the IaaS provider may, for each customer, set up a unique compute instance 944 that is contained in the service tenancy 919. Each compute instance 944 may allow communication between the control plane VCN 916, contained in the service tenancy 919, and the data plane VCN 918 that is contained in the customer tenancy 921. The compute instance 944 may allow resources, that are provisioned in the control plane VCN 916 that is contained in the service tenancy 919, to be deployed or otherwise used in the data plane VCN 918 that is contained in the customer tenancy 921.

In other examples, the customer of the IaaS provider may have databases that live in the customer tenancy 921. In this example, the control plane VCN 916 can include the data plane mirror app tier 940 that can include app subnet(s) 926. The data plane mirror app tier 940 can reside in the data plane VCN 918, but the data plane mirror app tier 940 may not live in the data plane VCN 918. That is, the data plane mirror app tier 940 may have access to the customer tenancy 921, but the data plane mirror app tier 940 may not exist in the data plane VCN 918 or be owned or operated by the customer of the IaaS provider. The data plane mirror app tier 940 may be configured to make calls to the data plane VCN 918 but may not be configured to make calls to any entity contained in the control plane VCN 916. The customer may desire to deploy or otherwise use resources in the data plane VCN 918 that are provisioned in the control plane VCN 916, and the data plane mirror app tier 940 can facilitate the desired deployment, or other usage of resources, of the customer.

In some embodiments, the customer of the IaaS provider can apply filters to the data plane VCN 918. In this embodiment, the customer can determine what the data plane VCN 918 can access, and the customer may restrict access to public Internet 954 from the data plane VCN 918. The IaaS provider may not be able to apply filters or otherwise control access of the data plane VCN 918 to any outside networks or databases. Applying filters and controls by the customer onto the data plane VCN 918, contained in the customer tenancy 921, can help isolate the data plane VCN 918 from other customers and from public Internet 954.

In some embodiments, cloud services 956 can be called by the service gateway 936 to access services that may not exist on public Internet 954, on the control plane VCN 916, or on the data plane VCN 918. The connection between cloud services 956 and the control plane VCN 916 or the data plane VCN 918 may not be live or continuous. Cloud services 956 may exist on a different network owned or operated by the IaaS provider. Cloud services 956 may be configured to receive calls from the service gateway 936 and may be configured to not receive calls from public Internet 954. Some cloud services 956 may be isolated from other cloud services 956, and the control plane VCN 916 may be isolated from cloud services 956 that may not be in the same region as the control plane VCN 916. For example, the control plane VCN 916 may be located in “Region 1,” and cloud service “Deployment 8,” may be located in Region 1 and in “Region 2.” If a call to Deployment 8 is made by the service gateway 936 contained in the control plane VCN 916 located in Region 1, the call may be transmitted to Deployment 8 in Region 1. In this example, the control plane VCN 916, or Deployment 8 in Region 1, may not be communicatively coupled to, or otherwise in communication with, Deployment 8 in Region 2.

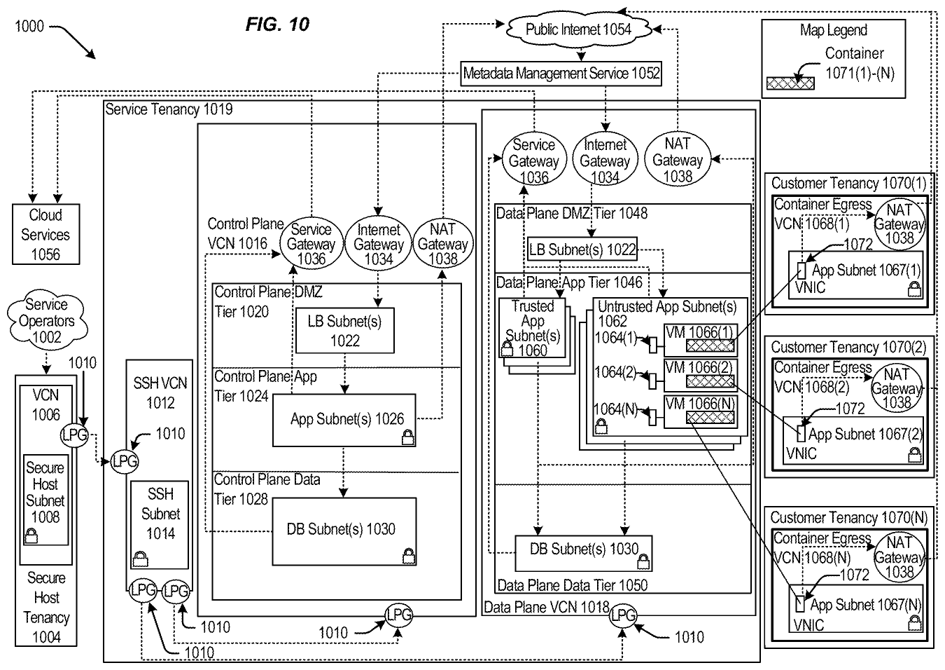

FIG. 10 is a block diagram 1000 illustrating another example pattern of an IaaS architecture, according to at least one embodiment. Service operators 1002 (e.g., service operators 802 of FIG. 8) can be communicatively coupled to a secure host tenancy 1004 (e.g., the secure host tenancy 804 of FIG. 8) that can include a virtual cloud network (VCN) 1006 (e.g., the VCN 806 of FIG. 8) and a secure host subnet 1008 (e.g., the secure host subnet 808 of FIG. 8). The VCN 1006 can include an LPG 1010 (e.g., the LPG 810 of FIG. 8) that can be communicatively coupled to an SSH VCN 1012 (e.g., the SSH VCN 812 of FIG. 8) via an LPG 1010 contained in the SSH VCN 1012. The SSH VCN 1012 can include an SSH subnet 1014 (e.g., the SSH subnet 814 of FIG. 8), and the SSH VCN 1012 can be communicatively coupled to a control plane VCN 1016 (e.g., the control plane VCN 816 of FIG. 8) via an LPG 1010 contained in the control plane VCN 1016 and to a data plane VCN 1018 (e.g., the data plane 818 of FIG. 8) via an LPG 1010 contained in the data plane VCN 1018. The control plane VCN 1016 and the data plane VCN 1018 can be contained in a service tenancy 1019 (e.g., the service tenancy 819 of FIG. 8).

The control plane VCN 1016 can include a control plane DMZ tier 1020 (e.g., the control plane DMZ tier 820 of FIG. 8) that can include load balancer (LB) subnet(s) 1022 (e.g., LB subnet(s) 822 of FIG. 8), a control plane app tier 1024 (e.g., the control plane app tier 824 of FIG. 8) that can include app subnet(s) 1026 (e.g., similar to app subnet(s) 826 of FIG. 8), a control plane data tier 1028 (e.g., the control plane data tier 828 of FIG. 8) that can include DB subnet(s) 1030. The LB subnet(s) 1022 contained in the control plane DMZ tier 1020 can be communicatively coupled to the app subnet(s) 1026 contained in the control plane app tier 1024 and to an Internet gateway 1034 (e.g., the Internet gateway 834 of FIG. 8) that can be contained in the control plane VCN 1016, and the app subnet(s) 1026 can be communicatively coupled to the DB subnet(s) 1030 contained in the control plane data tier 1028 and to a service gateway 1036 (e.g., the service gateway of FIG. 8) and a network address translation (NAT) gateway 1038 (e.g., the NAT gateway 838 of FIG. 8). The control plane VCN 1016 can include the service gateway 1036 and the NAT gateway 1038.

The data plane VCN 1018 can include a data plane app tier 1046 (e.g., the data plane app tier 846 of FIG. 8), a data plane DMZ tier 1048 (e.g., the data plane DMZ tier 848 of FIG. 8), and a data plane data tier 1050 (e.g., the data plane data tier 850 of FIG. 8). The data plane DMZ tier 1048 can include LB subnet(s) 1022 that can be communicatively coupled to trusted app subnet(s) 1060 and untrusted app subnet(s) 1062 of the data plane app tier 1046 and the Internet gateway 1034 contained in the data plane VCN 1018. The trusted app subnet(s) 1060 can be communicatively coupled to the service gateway 1036 contained in the data plane VCN 1018, the NAT gateway 1038 contained in the data plane VCN 1018, and DB subnet(s) 1030 contained in the data plane data tier 1050. The untrusted app subnet(s) 1062 can be communicatively coupled to the service gateway 1036 contained in the data plane VCN 1018 and DB subnet(s) 1030 contained in the data plane data tier 1050. The data plane data tier 1050 can include DB subnet(s) 1030 that can be communicatively coupled to the service gateway 1036 contained in the data plane VCN 1018.

The untrusted app subnet(s) 1062 can include one or more primary VNICs 1064(1)-(N) that can be communicatively coupled to tenant virtual machines (VMs) 1066(1)-(N). Each tenant VM 1066(1)-(N) can be communicatively coupled to a respective app subnet 1067(1)-(N) that can be contained in respective container egress VCNs 1068(1)-(N) that can be contained in respective customer tenancies 1070(1)-(N). Respective secondary VNICs 1072(1)-(N) can facilitate communication between the untrusted app subnet(s) 1062 contained in the data plane VCN 1018 and the app subnet contained in the container egress VCNs 1068(1)-(N). Each container egress VCNs 1068(1)-(N) can include a NAT gateway 1038 that can be communicatively coupled to public Internet 1054 (e.g., public Internet 854 of FIG. 8).

The Internet gateway 1034 contained in the control plane VCN 1016 and contained in the data plane VCN 1018 can be communicatively coupled to a metadata management service 1052 (e.g., the metadata management system 852 of FIG. 8) that can be communicatively coupled to public Internet 1054. Public Internet 1054 can be communicatively coupled to the NAT gateway 1038 contained in the control plane VCN 1016 and contained in the data plane VCN 1018. The service gateway 1036 contained in the control plane VCN 1016 and contained in the data plane VCN 1018 can be communicatively couple to cloud services 1056.

In some embodiments, the data plane VCN 1018 can be integrated with customer tenancies 1070. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 1046. Code to run the function may be executed in the VMs 1066(1)-(N), and the code may not be configured to run anywhere else on the data plane VCN 1018. Each VM 1066(1)-(N) may be connected to one customer tenancy 1070. Respective containers 1071(1)-(N) contained in the VMs 1066(1)-(N) may be configured to run the code. In this case, there can be a dual isolation (e.g., the containers 1071(1)-(N) running code, where the containers 1071(1)-(N) may be contained in at least the VM 1066(1)-(N) that are contained in the untrusted app subnet(s) 1062), which may help prevent incorrect or otherwise undesirable code from damaging the network of the IaaS provider or from damaging a network of a different customer. The containers 1071(1)-(N) may be communicatively coupled to the customer tenancy 1070 and may be configured to transmit or receive data from the customer tenancy 1070. The containers 1071(1)-(N) may not be configured to transmit or receive data from any other entity in the data plane VCN 1018. Upon completion of running the code, the IaaS provider may kill or otherwise dispose of the containers 1071(1)-(N).

In some embodiments, the trusted app subnet(s) 1060 may run code that may be owned or operated by the IaaS provider. In this embodiment, the trusted app subnet(s) 1060 may be communicatively coupled to the DB subnet(s) 1030 and be configured to execute CRUD operations in the DB subnet(s) 1030. The untrusted app subnet(s) 1062 may be communicatively coupled to the DB subnet(s) 1030, but in this embodiment, the untrusted app subnet(s) may be configured to execute read operations in the DB subnet(s) 1030. The containers 1071(1)-(N) that can be contained in the VM 1066(1)-(N) of each customer and that may run code from the customer may not be communicatively coupled with the DB subnet(s) 1030.

In other embodiments, the control plane VCN 1016 and the data plane VCN 1018 may not be directly communicatively coupled. In this embodiment, there may be no direct communication between the control plane VCN 1016 and the data plane VCN 1018. However, communication can occur indirectly through at least one method. An LPG 1010 may be established by the IaaS provider that can facilitate communication between the control plane VCN 1016 and the data plane VCN 1018. In another example, the control plane VCN 1016 or the data plane VCN 1018 can make a call to cloud services 1056 via the service gateway 1036. For example, a call to cloud services 1056 from the control plane VCN 1016 can include a request for a service that can communicate with the data plane VCN 1018.

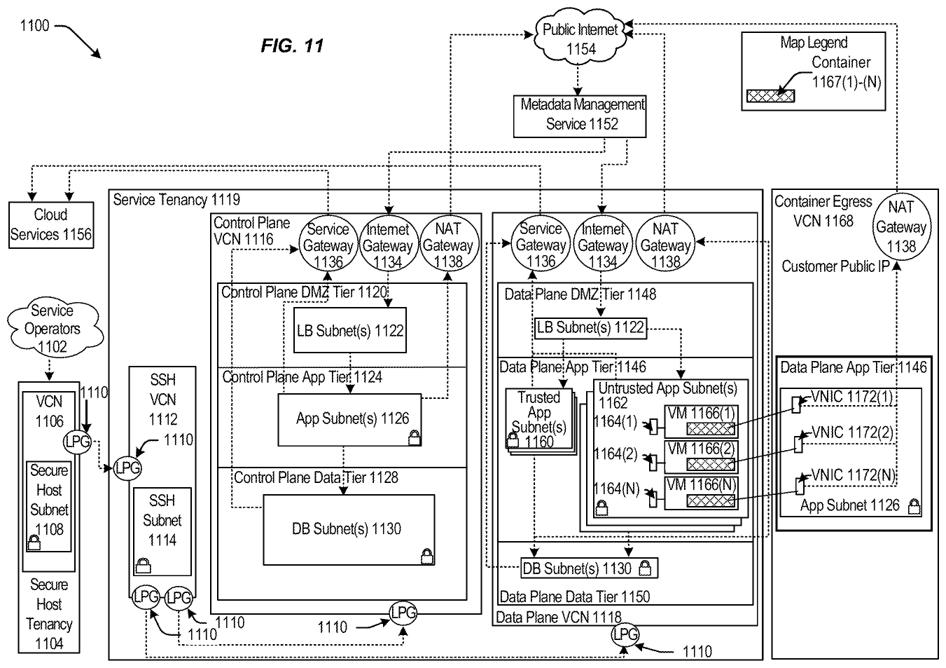

FIG. 11 is a block diagram 1100 illustrating another example pattern of an IaaS architecture, according to at least one embodiment. Service operators 1102 (e.g., service operators 802 of FIG. 8) can be communicatively coupled to a secure host tenancy 1104 (e.g., the secure host tenancy 804 of FIG. 8) that can include a virtual cloud network (VCN) 1106 (e.g., the VCN 806 of FIG. 8) and a secure host subnet 1108 (e.g., the secure host subnet 808 of FIG. 8). The VCN 1106 can include an LPG 1110 (e.g., the LPG 810 of FIG. 8) that can be communicatively coupled to an SSH VCN 1112 (e.g., the SSH VCN 812 of FIG. 8) via an LPG 1110 contained in the SSH VCN 1112. The SSH VCN 1112 can include an SSH subnet 1114 (e.g., the SSH subnet 814 of FIG. 8), and the SSH VCN 1112 can be communicatively coupled to a control plane VCN 1116 (e.g., the control plane VCN 816 of FIG. 8) via an LPG 1110 contained in the control plane VCN 1116 and to a data plane VCN 1118 (e.g., the data plane 818 of FIG. 8) via an LPG 1110 contained in the data plane VCN 1118. The control plane VCN 1116 and the data plane VCN 1118 can be contained in a service tenancy 1119 (e.g., the service tenancy 819 of FIG. 8).

The control plane VCN 1116 can include a control plane DMZ tier 1120 (e.g., the control plane DMZ tier 820 of FIG. 8) that can include LB subnet(s) 1122 (e.g., LB subnet(s) 822 of FIG. 8), a control plane app tier 1124 (e.g., the control plane app tier 824 of FIG. 8) that can include app subnet(s) 1126 (e.g., app subnet(s) 826 of FIG. 8), a control plane data tier 1128 (e.g., the control plane data tier 828 of FIG. 8) that can include DB subnet(s) 1130 (e.g., DB subnet(s) 1030 of FIG. 10). The LB subnet(s) 1122 contained in the control plane DMZ tier 1120 can be communicatively coupled to the app subnet(s) 1126 contained in the control plane app tier 1124 and to an Internet gateway 1134 (e.g., the Internet gateway 834 of FIG. 8) that can be contained in the control plane VCN 1116, and the app subnet(s) 1126 can be communicatively coupled to the DB subnet(s) 1130 contained in the control plane data tier 1128 and to a service gateway 1136 (e.g., the service gateway of FIG. 8) and a network address translation (NAT) gateway 1138 (e.g., the NAT gateway 838 of FIG. 8). The control plane VCN 1116 can include the service gateway 1136 and the NAT gateway 1138.

The data plane VCN 1118 can include a data plane app tier 1146 (e.g., the data plane app tier 846 of FIG. 8), a data plane DMZ tier 1148 (e.g., the data plane DMZ tier 848 of FIG. 8), and a data plane data tier 1150 (e.g., the data plane data tier 850 of FIG. 8). The data plane DMZ tier 1148 can include LB subnet(s) 1122 that can be communicatively coupled to trusted app subnet(s) 1160 (e.g., trusted app subnet(s) 1060 of FIG. 10) and untrusted app subnet(s) 1162 (e.g., untrusted app subnet(s) 1062 of FIG. 10) of the data plane app tier 1146 and the Internet gateway 1134 contained in the data plane VCN 1118. The trusted app subnet(s) 1160 can be communicatively coupled to the service gateway 1136 contained in the data plane VCN 1118, the NAT gateway 1138 contained in the data plane VCN 1118, and DB subnet(s) 1130 contained in the data plane data tier 1150. The untrusted app subnet(s) 1162 can be communicatively coupled to the service gateway 1136 contained in the data plane VCN 1118 and DB subnet(s) 1130 contained in the data plane data tier 1150. The data plane data tier 1150 can include DB subnet(s) 1130 that can be communicatively coupled to the service gateway 1136 contained in the data plane VCN 1118.

The untrusted app subnet(s) 1162 can include primary VNICs 1164(1)-(N) that can be communicatively coupled to tenant virtual machines (VMs) 1166(1)-(N) residing within the untrusted app subnet(s) 1162. Each tenant VM 1166(1)-(N) can run code in a respective container 1167(1)-(N), and be communicatively coupled to an app subnet 1126 that can be contained in a data plane app tier 1146 that can be contained in a container egress VCN 1168. Respective secondary VNICs 1172(1)-(N) can facilitate communication between the untrusted app subnet(s) 1162 contained in the data plane VCN 1118 and the app subnet contained in the container egress VCN 1168. The container egress VCN can include a NAT gateway 1138 that can be communicatively coupled to public Internet 1154 (e.g., public Internet 854 of FIG. 8).

The Internet gateway 1134 contained in the control plane VCN 1116 and contained in the data plane VCN 1118 can be communicatively coupled to a metadata management service 1152 (e.g., the metadata management system 852 of FIG. 8) that can be communicatively coupled to public Internet 1154. Public Internet 1154 can be communicatively coupled to the NAT gateway 1138 contained in the control plane VCN 1116 and contained in the data plane VCN 1118. The service gateway 1136 contained in the control plane VCN 1116 and contained in the data plane VCN 1118 can be communicatively couple to cloud services 1156.

In some examples, the pattern illustrated by the architecture of block diagram 1100 of FIG. 11 may be considered an exception to the pattern illustrated by the architecture of block diagram 1000 of FIG. 10 and may be desirable for a customer of the IaaS provider if the IaaS provider cannot directly communicate with the customer (e.g., a disconnected region). The respective containers 1167(1)-(N) that are contained in the VMs 1166(1)-(N) for each customer can be accessed in real-time by the customer. The containers 1167(1)-(N) may be configured to make calls to respective secondary VNICs 1172(1)-(N) contained in app subnet(s) 1126 of the data plane app tier 1146 that can be contained in the container egress VCN 1168. The secondary VNICs 1172(1)-(N) can transmit the calls to the NAT gateway 1138 that may transmit the calls to public Internet 1154. In this example, the containers 1167(1)-(N) that can be accessed in real-time by the customer can be isolated from the control plane VCN 1116 and can be isolated from other entities contained in the data plane VCN 1118. The containers 1167(1)-(N) may also be isolated from resources from other customers.

In other examples, the customer can use the containers 1167(1)-(N) to call cloud services 1156. In this example, the customer may run code in the containers 1167(1)-(N) that requests a service from cloud services 1156. The containers 1167(1)-(N) can transmit this request to the secondary VNICs 1172(1)-(N) that can transmit the request to the NAT gateway that can transmit the request to public Internet 1154. Public Internet 1154 can transmit the request to LB subnet(s) 1122 contained in the control plane VCN 1116 via the Internet gateway 1134. In response to determining the request is valid, the LB subnet(s) can transmit the request to app subnet(s) 1126 that can transmit the request to cloud services 1156 via the service gateway 1136.

It should be appreciated that IaaS architectures 800, 900, 1000, 1100 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

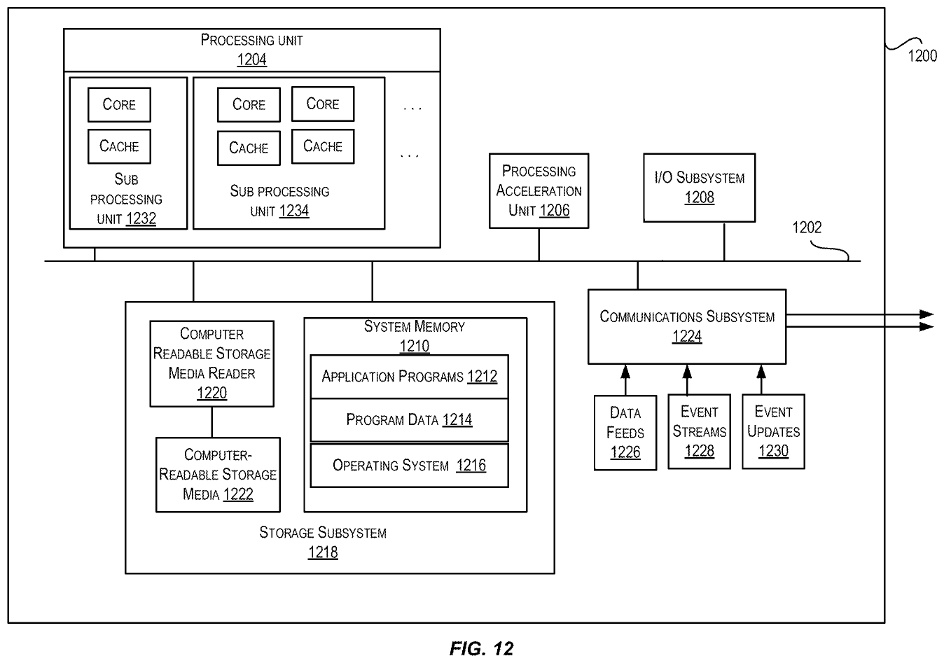

FIG. 12 illustrates an example computer system 1200, in which various embodiments may be implemented. The system 1200 may be used to implement any of the computer systems described above. As shown in the figure, computer system 1200 includes a processing unit 1204 that communicates with a number of peripheral subsystems via a bus subsystem 1202. These peripheral subsystems may include a processing acceleration unit 1206, an I/O subsystem 1208, a storage subsystem 1218 and a communications subsystem 1224. Storage subsystem 1218 includes tangible computer-readable storage media 1222 and a system memory 1210.

Bus subsystem 1202 provides a mechanism for letting the various components and subsystems of computer system 1200 communicate with each other as intended. Although bus subsystem 1202 is shown schematically as a single bus, alternative embodiments of the bus subsystem may utilize multiple buses. Bus subsystem 1202 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1204, which can be implemented as one or more integrated circuits (e.g., a conventional microprocessor or microcontroller), controls the operation of computer system 1200. One or more processors may be included in processing unit 1204. These processors may include single core or multicore processors. In certain embodiments, processing unit 1204 may be implemented as one or more independent processing units 1232 and/or 1234 with single or multicore processors included in each processing unit. In other embodiments, processing unit 1204 may also be implemented as a quad-core processing unit formed by integrating two dual-core processors into a single chip.

In various embodiments, processing unit 1204 can execute a variety of programs in response to program code and can maintain multiple concurrently executing programs or processes. At any given time, some or all of the program code to be executed can be resident in processor(s) 1204 and/or in storage subsystem 1218. Through suitable programming, processor(s) 1204 can provide various functionalities described above. Computer system 1200 may additionally include a processing acceleration unit 1206, which can include a digital signal processor (DSP), a special-purpose processor, and/or the like.

I/O subsystem 1208 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1200 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1200 may comprise a storage subsystem 1218 that comprises software elements, shown as being currently located within a system memory 1210. System memory 1210 may store program instructions that are loadable and executable on processing unit 1204, as well as data generated during the execution of these programs.

Depending on the configuration and type of computer system 1200, system memory 1210 may be volatile (such as random access memory (RAM)) and/or non-volatile (such as read-only memory (ROM), flash memory, etc.) The RAM typically contains data and/or program modules that are immediately accessible to and/or presently being operated and executed by processing unit 1204. In some implementations, system memory 1210 may include multiple different types of memory, such as static random access memory (SRAM) or dynamic random access memory (DRAM). In some implementations, a basic input/output system (BIOS), containing the basic routines that help to transfer information between elements within computer system 1200, such as during start-up, may typically be stored in the ROM. By way of example, and not limitation, system memory 1210 also illustrates application programs 1212, which may include client applications, Web browsers, mid-tier applications, relational database management systems (RDBMS), etc., program data 1214, and an operating system 1216. By way of example, operating system 1216 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems.

Storage subsystem 1218 may also provide a tangible computer-readable storage medium for storing the basic programming and data constructs that provide the functionality of some embodiments. Software (programs, code modules, instructions) that when executed by a processor provide the functionality described above may be stored in storage subsystem 1218. These software modules or instructions may be executed by processing unit 1204. Storage subsystem 1218 may also provide a repository for storing data used in accordance with the present disclosure.

Storage subsystem 1200 may also include a computer-readable storage media reader 1220 that can further be connected to computer-readable storage media 1222. Together and, optionally, in combination with system memory 1210, computer-readable storage media 1222 may comprehensively represent remote, local, fixed, and/or removable storage devices plus storage media for temporarily and/or more permanently containing, storing, transmitting, and retrieving computer-readable information.

Computer-readable storage media 1222 containing code, or portions of code, can also include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media. This can also include nontangible computer-readable media, such as data signals, data transmissions, or any other medium which can be used to transmit the desired information and which can be accessed by computing system 1200.

By way of example, computer-readable storage media 1222 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1222 may include, but is not limited to, Zip® drives, flash memory cards, universal serial bus (USB) flash drives, secure digital (SD) cards, DVD disks, digital video tape, and the like. Computer-readable storage media 1222 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1200.

Communications subsystem 1224 provides an interface to other computer systems and networks. Communications subsystem 1224 serves as an interface for receiving data from and transmitting data to other systems from computer system 1200. For example, communications subsystem 1224 may enable computer system 1200 to connect to one or more devices via the Internet. In some embodiments communications subsystem 1224 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments communications subsystem 1224 can provide wired network connectivity (e.g., Ethernet) in addition to or instead of a wireless interface.

In some embodiments, communications subsystem 1224 may also receive input communication in the form of structured and/or unstructured data feeds 1226, event streams 1228, event updates 1230, and the like on behalf of one or more users who may use computer system 1200.

By way of example, communications subsystem 1224 may be configured to receive data feeds 1226 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1224 may also be configured to receive data in the form of continuous data streams, which may include event streams 1228 of real-time events and/or event updates 1230, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1224 may also be configured to output the structured and/or unstructured data feeds 1226, event streams 1228, event updates 1230, and the like to one or more databases that may be in communication with one or more streaming data source computers coupled to computer system 1200.

Computer system 1200 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1200 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or modules are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A method comprising:
obtaining, by a computing system, a common interface format (CIF) application programming interface (API) document, the CIF API document generated based on an application programming interface (API) document that is relevant to a source entity;
identifying, by the computing system, one or more relevant portions within the CIF API document for further processing;
for a relevant portion in the one or more relevant portions that is identified for further processing, identifying, by the computing system, one or more component types within the relevant portion;
for a component type from the one or more component types identified in the relevant portion, identifying, by the computing system, content related to the component type;
transforming, by the computing system, the content related to the component type based on a set of transformation rules associated with the component type; and
generating, by the computing system, a target entity-specific API document for a target entity, the target entity-specific API document including the transformed content related to the component type identified in the relevant portion.

2. The method of claim 1, further comprising identifying one or more component instances related to the component type, wherein identifying the content related to the component type further comprises identifying the content related to the one or more component instances.

3. The method of claim 2, wherein transforming the content related to the component type based on the set of transformation rules further comprises:
transforming the content in the one or more component instances related to the component type based on the set of transformation rules.

4. The method of claim 1, wherein the CIF API document comprises a set of API definitions for describing one or more elements of the API document that is relevant to the source entity using a standard API description format.

5. The method of claim 1, wherein the one or more relevant portions within the CIF API document are identified by applying a filtering operation to the CIF API document, wherein the one or more relevant portions identify one or more resources in the CIF API document that are relevant to the target entity-specific API document.

6. The method of claim 1, wherein the one or more relevant portions identify one or more generic portions of the CIF API document that are relevant to the target entity-specific API document.

7. The method of claim 1, wherein the one or more component types in the relevant portion represent one or more operation types that are applied to a resource identified in the relevant portion.

8. The method of claim 1, wherein the content related to the component type identified in the relevant portion comprises information identifying the resource identified in the relevant portion, wherein the information identifying the resource comprises path information used to access the resource, a description of an operation type applied to the resource, an operation identifier used to identify the operation type, the input parameters used by the operation type, the output parameters used by the operation type and the response schema associated with the operation type.

9. The method of claim 1, wherein a transformation rule in the set of transformation rules transforms a portion of the content associated with the component type to generate a portion of the transformed content related to the component type identified in the relevant portion.

10. The method of claim 9, wherein the portion of the content associated with the component type corresponds to an operation type, and wherein the transformation rule transforms the portion of the content associated with the operation type by classifying the operation type into a particular group from a set of groups and annotating the particular group with semantic information specific to the target entity.

11. The method of claim 10, wherein the transformation rule further transforms the portion of the content associated with the operation type by renaming the operation type into a format specified by the target entity.

12. The method of claim 9, wherein the portion of the content associated with the component type corresponds to path information associated with an operation type, and wherein the transformation rule transforms the portion of the content associated with the path information by removing parameter information that identifies the source entity.

13. The method of claim 9, wherein the portion of the content associated with the component type corresponds to an operation identifier associated with an operation type, and wherein the transformation rule transforms the portion of the content associated with the operation identifier by remaining the operation identifier into a format specified by the target entity.

14. The method of claim 9, wherein the portion of the content associated with the component type corresponds to a data model associated with the component type and wherein the transformation rule transforms the portion of the content associated with the data model by generating a new data model in a format specified by the target entity.

15. The method of claim 1, wherein the target entity represents a target enterprise for which the target entity-specific API document is generated or a target cloud service provider for which the target entity-specific API document is generated.

16. An Application Programming Interface (API) generation system comprising:
a memory; and
one or more processors configured to perform processing, the processing 45 comprising:
obtaining a common interface format (CIF) application programming interface (API) document, the CIF API document generated based on an application programming interface (API) document that is relevant to a source entity;
identifying one or more relevant portions within the CIF API document for further processing;
for a relevant portion in the one or more relevant portions that is identified for further processing, identifying one or more component types within the relevant portion;
for a component type from the one or more component types identified in the relevant portion, identifying content related to the component type;
transforming the content related to the component type based on a set of transformation rules associated with the component type; and
generating a target entity-specific API document for a target entity, the target entity-specific API document including the transformed content related to the component type identified in the relevant portion.

17. The system of claim 16, wherein the one or more relevant portions within the CIF API document are identified by applying a filtering operation to the CIF API document, wherein the one or more relevant portions identify one or more resources in the CIF API document that are relevant to the target entity-specific API document.

18. The system of claim 16, wherein the one or more component types in the relevant portion comprise one or more operation types that are applied to a resource identified in the relevant portion.

19. A non-transitory computer-readable medium storing instructions executable by a computer system that, when executed by one or more processors of the computer system, cause the one or more processors to perform operations comprising:
obtaining a common interface format (CIF) application programming interface (API) document, the CIF API document generated based on an application programming interface (API) document that is relevant to a source entity;
identifying one or more relevant portions within the CIF API document for further processing;
for a relevant portion in the one or more relevant portions that is identified for further processing, identifying one or more component types within the relevant portion;
for a component type from the one or more component types identified in the relevant portion, identifying content related to the component type;
transforming the content related to the component type based on a set of transformation rules associated with the component type; and
generating a target entity-specific API document for a target entity, the target entity-specific API document including the transformed content related to the component type identified in the relevant portion.

20. The non-transitory computer-readable medium of claim 19, wherein identifying the content related to the component type further comprises:
identifying one or more component instances related to the component type, and wherein identifying the content related to the component type further comprises identifying the content related to the one or more component instances.
